(19) United States
(12) Patent Application Publication
(10) Pub. No.: US 2025/0211691 A1
(43) Pub. Date: Jun. 26, 2025

(54) IMAGER AND IMAGE READING APPARATUS

(71) Applicant: PFU LIMITED, Kahoku-shi, ISHIKAWA (JP)

(72) Inventor: Itsuki Oishi, Kahoku-shi (JP)

(21) Appl. No.: 18/982,282

(22) Filed: Dec. 16, 2024

(30) Foreign Application Priority Data
Dec. 26, 2023 (JP) 2023-220072

(51) Int. Cl. H04N 1/00; B41J 29/02

(52) U.S. Cl. CPC H04N 1/00559; B41J 29/02; H04N 2201/0094

(57) ABSTRACT

An imager includes an imaging circuit board including a hole, a frame including a projection, and a restrictor. The projection includes a base and an end portion projecting from the hole. The restrictor is located between the end portion and the hole and includes an opening through which the base passes. The imaging circuit board is fixed to the frame by the end portion and the restrictor, and the opening is smaller than the hole in a main scanning direction of the imaging circuit board.

### CROSS-REFERENCE TO RELATED APPLICATIONS

This patent application is based on and claims priority pursuant to 35 U.S.C. § 119(a) to Japanese Patent Application No. 2023-220072, filed on Dec. 26, 2023, in the Japan Patent Office, the entire disclosure of which is hereby incorporated by reference herein.

### BACKGROUND

The present disclosure relates to an imager and an image reading apparatus.

An imager used in an image reading apparatus such as a scanner that images a medium is adjusted to focus on the position of the medium to be imaged. However, the frame of the imager may be deformed in a bow shape depending on the environment (particularly, the temperature environment) in which the image reading apparatus is used. In this case, the focus of the imager may be deviated from the position of the medium, and the image obtained by imaging the medium may be blurred.

A related-art image sensor unit includes a condenser to condense light from an object to be read, an image sensor, a body frame that contains the condenser and the image sensor, and a long rigid member mounted on a side face of the body frame extending in the longitudinal direction of the body frame. In this image sensor unit, the side face of the body frame includes an attachment projection, and the long rigid member includes an attachment hole penetrating from a face facing the side face of the body frame to a non-facing face on the opposite side. The attachment projection is inserted into the attachment hole, and an end portion of the attachment projection (a portion of the rigid member projecting from the attachment hole) is thermally deformed to overlap the periphery of the attachment hole.

### SUMMARY

The imager according to one aspect of the present disclosure includes an imaging circuit board including a hole, a frame including a projection, and a restrictor. The projection includes a base and an end portion projecting from the hole. The restrictor is located between the end portion and the hole and includes an opening through which the base passes. The imaging circuit board is fixed to the frame by the end portion and the restrictor, and the opening is smaller than the hole in a main scanning direction of the imaging circuit board.

The image reading apparatus according to another aspect of the present disclosure includes the above-described imager and control circuitry to control imaging operation performed by the imager.

The imager according to still another aspect of the present disclosure includes an imaging circuit board including a hole, and a frame including a projection. The projection includes a base and an end portion projecting from the hole. The end portion is longer than the base in a sub-scanning direction of the imaging circuit board and is equal to or shorter than the base in a main scanning direction of the imaging circuit board. The imaging circuit board is fixed to the frame by the end portion in the sub-scanning direction.

The image reading apparatus according to still another aspect of the present disclosure includes the above-described imager and control circuitry to control imaging operation performed by the imager.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image reading apparatus according to one embodiment of the present disclosure;

FIG. 2 is a diagram for explaining a medium conveying path inside the image reading apparatus illustrated in FIG. 2;

FIG. 3 is a schematic diagram for explaining an imager according to one embodiment;

FIGS. 4A and 4B are respectively a perspective view and a plan view of a first imaging circuit board of the imager illustrated in FIG. 3;

FIGS. 5A and 5B are respectively a perspective view and a plan view of a first frame of the imager illustrated in FIG. 3;

FIG. 6 is a perspective view of the first frame illustrated in FIGS. 3A and 3B;

FIGS. 7A and 7B are respectively an enlarged view and a cross-sectional view of an area including a first projection on the first frame illustrated in FIG. 6;

FIGS. 8A to 8D are schematic diagrams for explaining the process of attaching the first imaging circuit board to the first frame illustrated in FIG. 6;

FIGS. 9A and 9B are schematic diagrams for explaining a technical significance of restricting a part of a melted end portion of the first projection from flowing into the first hole in the process illustrated in FIGS. 8A to 8D;

FIG. 10 is a schematic block diagram of the image reading apparatus according to one embodiment;

FIG. 11 is a schematic block diagram of a memory and a processing circuit illustrated in FIG. 10;

FIG. 12 is a flowchart of an example operations in a medium reading process;

FIGS. 13A to 13C are schematic diagrams for explaining another imager;

FIGS. 14A to 14C are schematic diagrams for explaining the process of attaching a first imaging circuit board illustrated in FIGS. 13A to 13C to the first frame;

FIGS. 15A and 15B are schematic diagrams for explaining still another imager;

FIGS. 16A to 16C are schematic diagrams for explaining still another imager;

FIGS. 17A to 17C are schematic views for explaining the process of attaching a first imaging circuit board illustrated in FIGS. 16A to 136 to the first frame; and

FIG. 18 is a schematic block diagram of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, imagers and image reading apparatuses according to embodiments of the present disclosure are described below. As used herein, the singular forms “a,” “an,” and “the” are intended to include the plural forms as well, unless the context clearly indicates otherwise.

The technical scope of the present disclosure is not limited to the embodiments described below and covers equivalents of elements described below. Thus, numerous additional modifications and variations are possible in light of the above teachings.

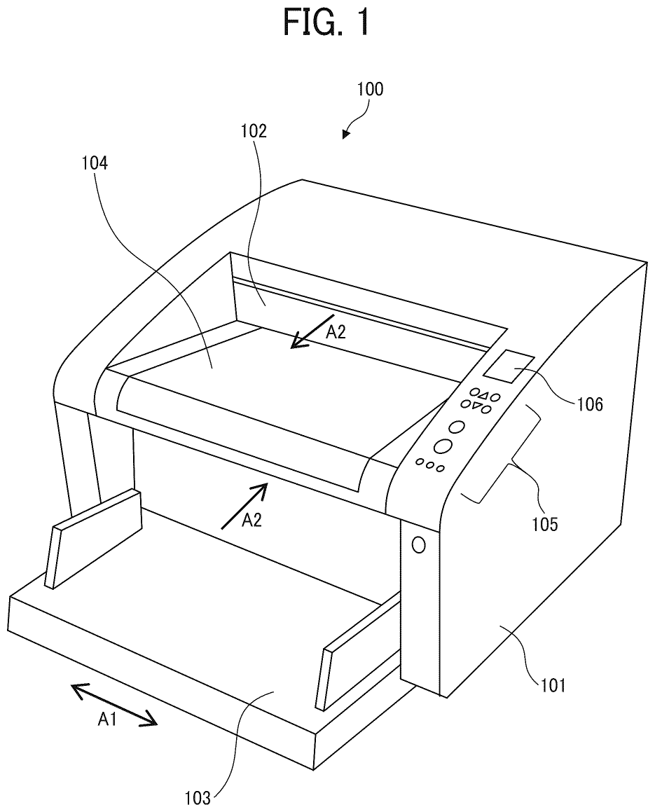

FIG. 1 is a perspective view of an image reading apparatus 100, which is an image scanner. The image reading apparatus 100 conveys a medium that is a document and images the medium. The medium is, for example, a plain paper sheet, a thick paper sheet, or a card. The image reading apparatus 100 may be a facsimile machine, a copier, or a multifunction peripheral (MFP). An MFP may be also called a multifunction printer.

In FIG. 1, arrow A1 indicates the width direction perpendicular to the direction in which a medium is conveyed indicated by arrow A2. These directions may be referred to as the width direction A1 and the medium conveying direction A2, respectively, in the following description. In the following, upstream is upstream in the medium conveying direction A2, and downstream is downstream in the medium conveying direction A2.

The image reading apparatus 100 includes a first housing 101, a second housing 102, a media tray 103, an ejection tray 104, an operation device 105, and a display device 106.

The second housing 102 is located inside the first housing 101. The second housing 102 is rotatably hinged to the first housing 101 to open and close for removing a jammed medium or cleaning the inside of the image reading apparatus 100.

The media tray 103 is engaged with the first housing 101 such that the medium to be conveyed can be placed on the media tray 103. The media tray 103 is located on a side of the first housing 101 from which the medium is fed into the first housing 101. The media tray 103 is movable in the height direction perpendicular to the width direction A1 and the medium conveying direction A2. When no medium is conveyed, the media tray 103 is located at the lower end of the movable range to facilitate the placement of the medium thereon. When a medium is conveyed, the media tray 103 is raised to the position at which the medium on the top of the media tray 103 contacts a pick roller described later.

The ejection tray 104 is formed on the second housing 102. The ejection tray 104 receives the medium ejected from an ejection port formed by the first housing 101 and the second housing 102.

The operation device 105 includes an input device such as a button and an interface circuit that receives signals from the input device. The operation device 105 receives an input operation performed by a user and outputs an operation signal corresponding to the input operation performed by the user. The display device 106 includes a display and an interface circuit that outputs image data to the display and displays the image data on the display. Examples of the display include a liquid crystal display and an organic electro-luminescence (EL) display.

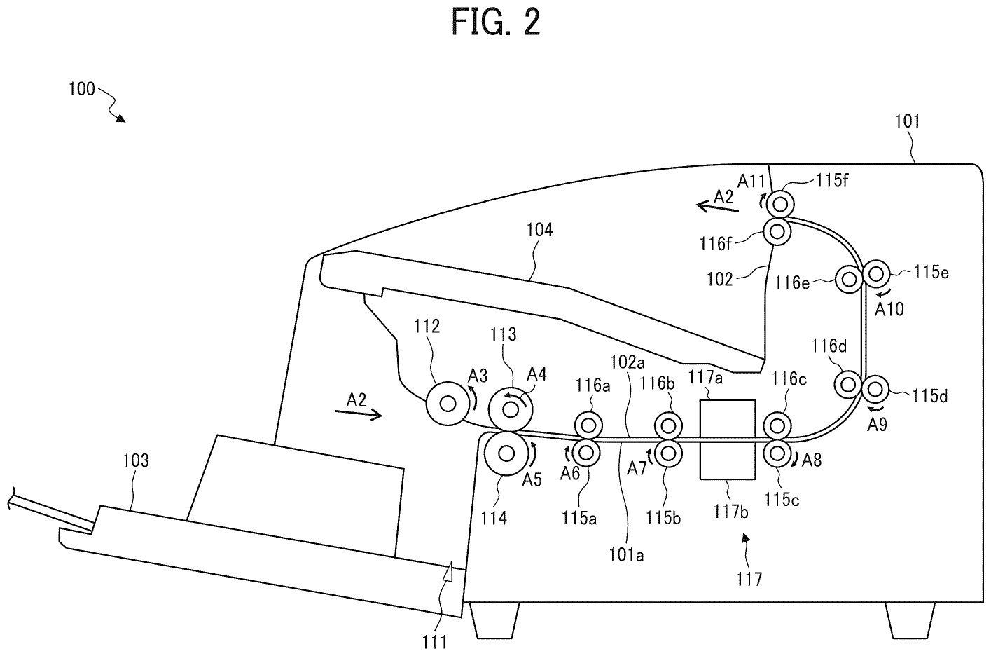

FIG. 2 is a diagram for explaining a medium conveying path inside the image reading apparatus 100.

The image reading apparatus 100 includes a media sensor 111, a pick roller 112, a feed roller 113, a separation roller 114, first to sixth conveyance rollers 115a to 115f, first to sixth driven rollers 116a to 116f, and an imager 117 along the medium conveying path.

The number of any one, some, or all of the pick roller 112, the feed roller 113, the separation roller 114, the first to sixth conveyance rollers 115a to 115f, and the first to sixth driven rollers 116a to 116f is not limited to one, and may be two or more. When one, some, or all of the feed roller 113, the separation roller 114, the first to sixth conveyance rollers 115a to 115f, and the first to sixth driven rollers 116a to 116f are formed of multiple rollers, the multiple rollers are arranged at intervals in the width direction A1.

The second housing 102 faces the first housing 101 across the medium conveying path. The face of the first housing 101 facing the second housing 102 forms a first guide 101a of the medium conveying path. The face of the second housing 102 facing the first housing 101 forms a second guide 102a of the medium conveying path. The first guide 101a and the second guide 102a define a so-called U-turn path.

The media sensor 111 is located on the media tray 103 and upstream from the feed roller 113 and the separation roller 114 and detects whether a medium is placed on the media tray 103. The media sensor 111 is a contact detection sensor that includes an arm movable by contact with the medium, a light emitter, and a light receiver that faces the light emitter across the arm. The light emitter is, for example, a light-emitting diode (LED) and emits light toward the light receiver. The light receiver is, for example, a photodiode and receives light emitted from the light emitter. The arm blocks the light emitted from the light emitter to the receiver in one of the state of contact with a medium and the state of non-contact with the medium. The arm does not block the light in the other state. The media sensor 111 generates and outputs a media signal whose signal value changes between the state of contact with a medium and the state of non-contact with the medium. In other words, the signal value of the media signal changes between the state where a medium is placed on the media tray 103 and the state where no medium is placed thereon.

The media sensor 111 may be any sensor that detects a medium placed on the media tray 103. An example of such a sensor is a light detection sensor including a light emitter to emit light to or from the media tray 103 and a light receiver to detect the light emitted from the light emitter and reflected by the medium placed on the media tray 103.

The pick roller 112 is located upstream from the feed roller 113 and the separation roller 114 in the second housing 102 in the medium conveying direction A2. The pick roller 112 contacts the top medium of the media placed on the media tray 103 raised to substantially the same height as the height of the medium conveying path, and feeds (conveys) the top medium downstream in the medium conveying direction A2.

The feed roller 113 is located downstream from the pick roller 112 in the second housing 102 and feeds (conveys) the medium fed from the media tray 103 by the pick roller 112 further downstream in the medium conveying direction A2. The separation roller 114 faces the feed roller 113 in the first housing 101. The separation roller 114 is a so-called brake roller or retard roller and is rotatable in the direction opposite to the rotation direction for conveying the media (may be referred to as a medium feeding direction in the following description). Alternatively, the separation roller 114 is stoppable. The feed roller 113 and the separation roller 114 separate the media to feed the media one by one. The feed roller 113 is located above the separation roller 114, and the image reading apparatus 100 feeds the media from the top. Instead of the separation roller 114, a separation pad may be used.

The first to sixth conveyance rollers 115a to 115f and the first to sixth driven rollers 116a to 116f are located downstream from the pick roller 112, the feed roller 113, and the separation roller 114 in the medium conveying direction A2 such that the first to sixth conveyance rollers 115a to 115f face the first to sixth driven rollers 116a to 116f, respectively. The first to sixth conveyance rollers 115a to 115f and the first to sixth driven rollers 116a to 116f convey a medium fed by the feed roller 113 and the separation roller 114 downstream in the medium conveying direction A2. The sixth conveyance roller 115f and the sixth driven roller 116f eject the medium conveyed by the pick roller 112, the feed roller 113, the separation roller 114, the first to fifth conveyance rollers 115a to 115e, and the first to fifth driven rollers 116a to 116e onto the ejection tray 104.

The imager 117 is located downstream from the first and second conveyance rollers 115a and 115b in the medium conveying direction A2 and images the medium conveyed by the first and second conveyance rollers 115a and 115b and the first and second driven rollers 116a and 116b. The imager 117 includes a first imager 117a and a second imager 117b facing each other across the medium conveying path. The first imager 117a is located in the second housing 102, and the second imager 117b is located in the first housing 101.

The medium placed on the media tray 103 is conveyed between the first guide 101a and the second guide 102a in the medium conveying direction A2 by the pick roller 112 and the feed roller 113 rotating in the medium feeding directions indicated by arrows A3 and A4, respectively. When the separation roller 114 stops or rotates in the direction indicated by arrow A5 opposite to the medium feeding direction, the feeding of a medium other than the separated medium is prevented. In short, the multi-feed is prevented.

The medium is conveyed to an imaging position of the imager 117 by the first and second conveyance rollers 115a and 115b rotating in the directions indicated by arrows A6 and A7, respectively, while being guided by the first guide 101a and the second guide 102a. Then, the medium is imaged by the imager 117. Further, the medium is ejected onto the ejection tray 104 by the third to sixth conveyance rollers 115c to 115f rotating in the directions indicated by arrows A8 to A11, respectively.

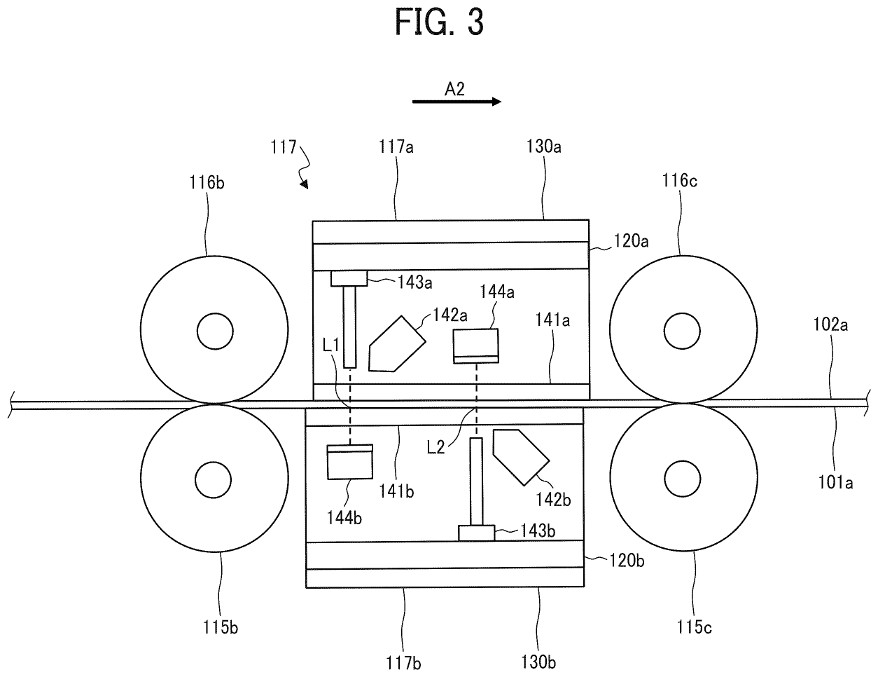

FIG. 3 is a schematic diagram for explaining the imager 117.

As illustrated in FIG. 3, the first imager 117a includes a first imaging circuit board 120a, a first frame 130a, a first light transmitting member 141a, a first light source 142a, a first imaging sensor 143a, a first backing member 144a. The second imager 117b includes a second imaging circuit board 120b, a second frame 130b, a second light transmitting member 141b, a second light source 142b, a second imaging sensor 143b, and a second backing member 144b.

The first imaging circuit board 120a and the second imaging circuit board 120b are examples of an imaging circuit board. The first imaging circuit board 120a is a printed board (circuit board) formed of a base and resin. The base is made of, for example, paper or glass fabric. Examples of resin include phenolic resin or epoxy resin. The first imaging circuit board 120a is mounted with the first imaging sensor 143a and a wiring pattern to transmit control signals from a processing circuit described later to the first imaging sensor 143a and the first light source 142a. Similarly, the second imaging circuit board 120b is a printed board (circuit board) formed of a base and resin. The base is made of, for example, paper or glass fabric. Examples of resin include phenolic resin or epoxy resin. The second imaging circuit board 120b is mounted with the second imaging sensor 143b and a wire pattern to transmit control signals from the processing circuit described later to the second imaging sensor 143b and the second light source 142b.

The first frame 130a and the second frame 130b are examples of a frame. The first frame 130a is the housing of the first imager 117a. The first frame 130a is made of a resin material such as polypropylene, polyethylene, polystyrene, or polyvinyl chloride different from the resin material of the first imaging circuit board 120a. Particularly, the first frame 130a is made of a resin material having a higher coefficient of linear expansion than the resin material of the first imaging circuit board 120a. The first imaging circuit board 120a, the first light transmitting member 141a, the first light source 142a, the first imaging sensor 143a, and the first backing member 144a are located inside the first frame 130a. Similarly, the second frame 130b is the housing of the second imager 117b. The second frame 130b is made of a resin material such as polypropylene, polyethylene, polystyrene, or polyvinyl chloride different from the resin material of the second imaging circuit board 120b. Particularly, the second frame 130b is formed of a resin material having a higher coefficient of linear expansion than the resin material of the second imaging circuit board 120b. The second imaging circuit board 120b, the second light transmitting member 141b, the second light source 142b, the second imaging sensor 143b, and the second backing member 144b are located inside the second frame 130b.

The first light transmitting member 141a and the second light transmitting member 141b are formed of transparent glass. Alternatively, the first light transmitting member 141a and the second light transmitting member 141b may be formed of transparent plastic or the like. The first light transmitting member 141a and the second light transmitting member 141b form the medium conveying path.

The first light source 142a is located opposite to the second backing member 144b across the medium conveying path. The first light source 142a includes a light emitting diode (LED) located at an end of the first imager 117a in the main scanning direction, and a light guide extending in the main scanning direction. The light guide guides the light emitted from the LED toward the medium conveying path. The first light source 142a emits light toward the front surface of the medium conveyed to the position of the imager 117 (or toward the facing second backing member 144b of the second imager 117b when no medium is conveyed). Similarly, the second light source 142b is located opposite to the first backing member 144a across the medium conveying path. The second light source 142b includes an LED located at an end of the second imager 117b in the main scanning direction, and a light guide extending in the main scanning direction. The light guide guides the light emitted from the LED toward the medium conveying path. The second light source 142b emits light toward the back surface of the medium conveyed to the position of the imager 117 (or toward the facing first backing member 144a of the first imager 117a when no medium is conveyed.

The first imaging sensor 143a is located opposite to the second backing member 144b across the medium conveying path. The first imaging sensor 143a includes a line sensor based on a unity-magnification contact image sensor (CIS). The CIS includes complementary metal oxide semiconductor (CMOS) imaging elements arranged linearly in the main scanning direction. The first imaging sensor 143a further includes a lens that forms an image on the imaging elements and an analog-to-digital (A/D) converter that amplifies the electrical signals output from the imaging elements and performs analog-to-digital (A/D) conversion. The first imaging sensor 143a images the front surface of the conveyed medium at an imaging position L1 to generate an input image and outputs the input image. When no medium is conveyed, the first imaging sensor 143a images the second backing member 144b to generate a reference image and outputs the reference image.

Similarly, the second imaging sensor 143b is located opposite to the first backing member 144a across the medium conveying path. The second imaging sensor 143b includes a line sensor based on a unity-magnification CIS including CMOS imaging elements arranged linearly in the main scanning direction. The second imaging sensor 143b further includes a lens that forms an image on the imaging elements and an A/D converter that amplifies the electrical signals output from the imaging elements and performs A/D conversion. The second imaging sensor 143b images the back surface of the conveyed medium at an imaging position L2 to generate an input image and outputs the input image. When no medium is conveyed, the second imaging sensor 143b images the first backing member 144a to generate a reference image and outputs the reference image.

Instead of the line sensor based on a unity-magnification CIS including CMOS imaging elements, a line sensor based on a unity-magnification CIS including charge-coupled device (CCD) imaging elements may be used. Alternatively, a reduction-optical type line sensor including CMOS or CCD imaging elements may be used.

The first backing member 144a is plate shaped, extends in the main scanning direction, and is located above the first light transmitting member 141a and at a position facing the second light source 142b and the second imaging sensor 143b. The first backing member 144a is, for example, white colored and functions as a white reference for image correction such as shading based on the reference image obtained by imaging the first backing member 144a. Similarly, the second backing member 144b is a plate shaped, extends in the main scanning direction, and is located below the second light transmitting member 141b and at a position facing the first light source 142a and the first imaging sensor 143a. The second backing member 144b is, for example, white colored and functions as a white reference for image correction such as shading based on the reference image obtained by imaging the second backing member 144b.

The image reading apparatus 100 may include either the first imager 117a or the second imager 117b to read only one side of the medium.

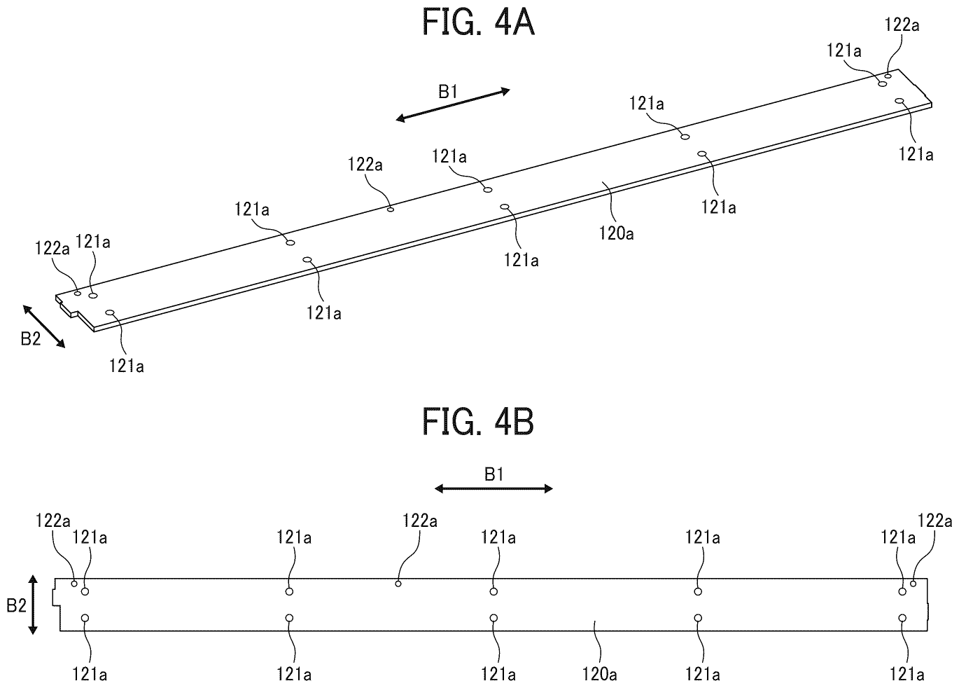

FIG. 4A is a perspective view of the first imaging circuit board 120a before being attached to the first frame 130a, as viewed obliquely from above. FIG. 4B is a plan view of the first imaging circuit board 120a before being attached to the first frame 130a, as viewed from above.

In FIGS. 4A and 4B, arrow B1 indicates the main scanning direction of the imager 117, and arrow B2 indicates the sub-scanning direction of the imager 117. When the imager 117 is in the image reading apparatus 100, the main scanning direction B1 is substantially the same direction as the width direction A1, and the sub-scanning direction B2 is substantially the same direction as the medium conveying direction A2. Since the structures of the first imager 117a and the second imager 117b are similar, the first imager 117a will be described below as a representative.

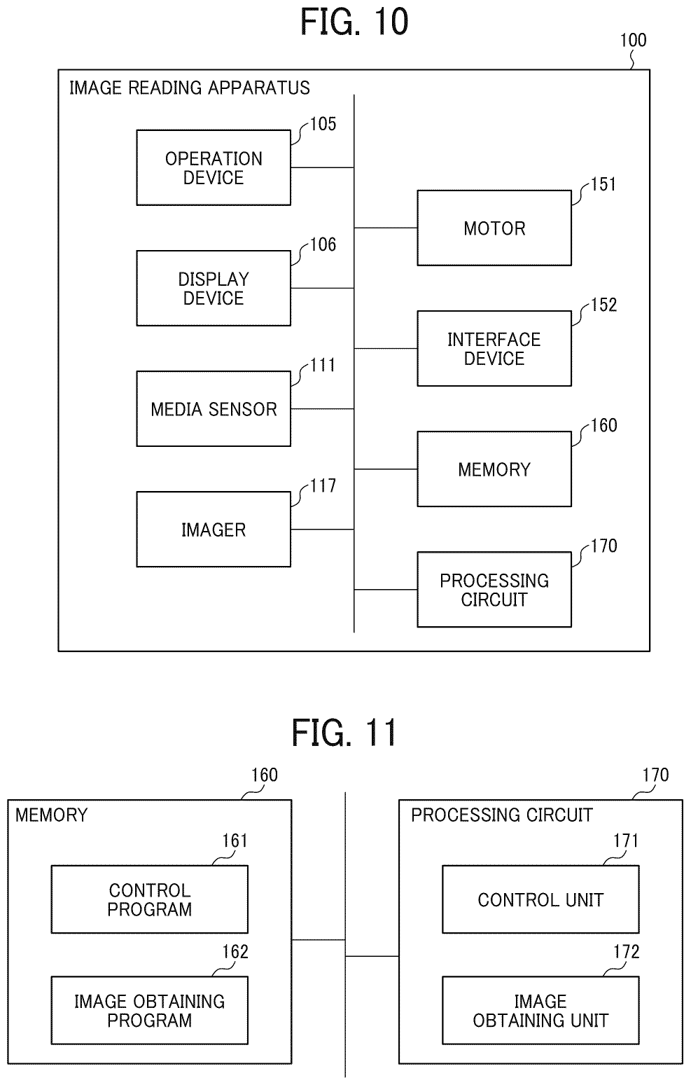

As illustrated in FIGS. 4A and 4B, the first imaging circuit board 120a has first holes 121a and second holes 122a. The first holes 121a are examples of a hole. In the example illustrated in FIGS. 4A and 4B, 10 first holes 121a are formed in the first imaging circuit board 120a. The first holes 121a are arranged in five rows spaced in the main scanning direction B1 and are arranged in two rows spaced in the sub-scanning direction B2. The number of the first holes 121a may be one, two, or more.

In the example illustrated in FIGS. 4A and 4B, three second holes 122a are formed in the first imaging circuit board 120a. The second holes 122a are arranged in three rows spaced in the main scanning direction B1 and are arranged in one row in the sub-scanning direction B2. The number of the second holes 122a may be one, two, or more. The second holes 122a may be arranged in multiple rows spaced in the sub-scanning direction B2.

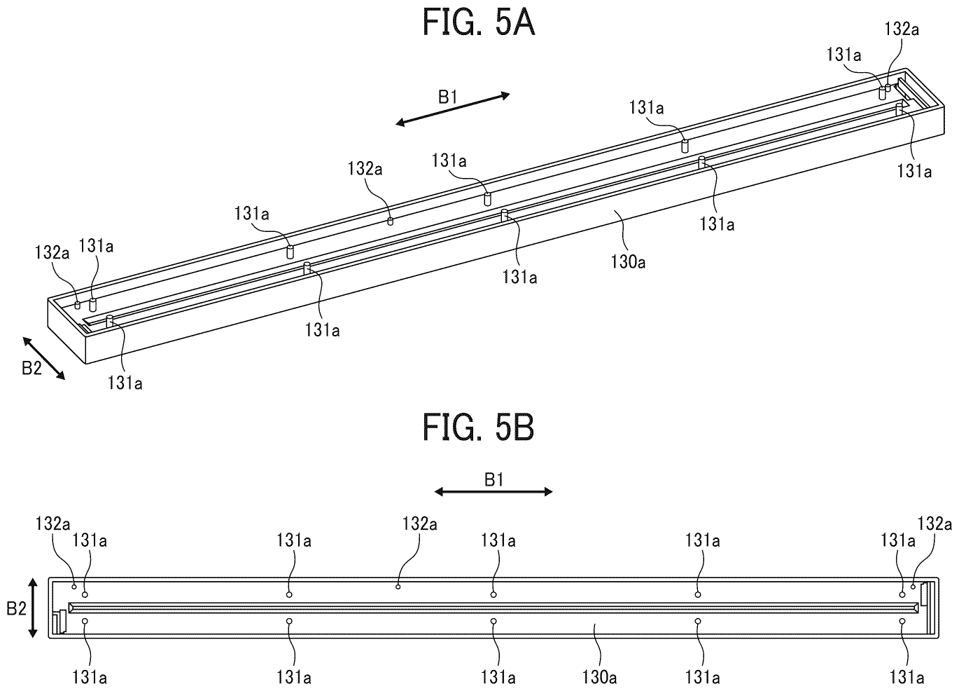

FIG. 5A is a perspective view of the first frame 130a before the first imaging circuit board 120a is attached, as viewed obliquely from above. FIG. 5B is a plan view of the first frame 130a before the first imaging circuit board 120a is attached, as viewed from above.

As illustrated in FIGS. 5A and 5B, the first frame 130a includes first projections 131a and second projections 132a. The first projections 131a are examples of a projection. The first projections 131a and the second projections 132a are bosses located to face the first holes 121a and the second holes 122a of the first imaging circuit board 120a, respectively. The first projections 131a and the second projections 132a are integral with the first frame 130a. Any one of or both the first projections 131a and the second projections 132a may be formed separately from the first frame 130a. In this case, the first projections 131a are made of a resin melted by heat. In the example illustrated in FIGS. 5A and 5B, the first frame 130a includes 10 first projections 131a. The first projections 131a are arranged in five rows spaced in the main scanning direction B1 and in two rows spaced in the sub-scanning direction B2. The number of the first projections 131a may be one, two, or more.

In the example illustrated in FIGS. 5A and 5B, the first frame 130a includes three second projections 132a. The second projections 132a are arranged in three rows spaced in the main scanning direction B1 and in one row in the sub-scanning direction B2. The number of the second projections 132a may be one, two, or more. The second projections 132a may be arranged in multiple rows spaced in the sub-scanning direction B2.

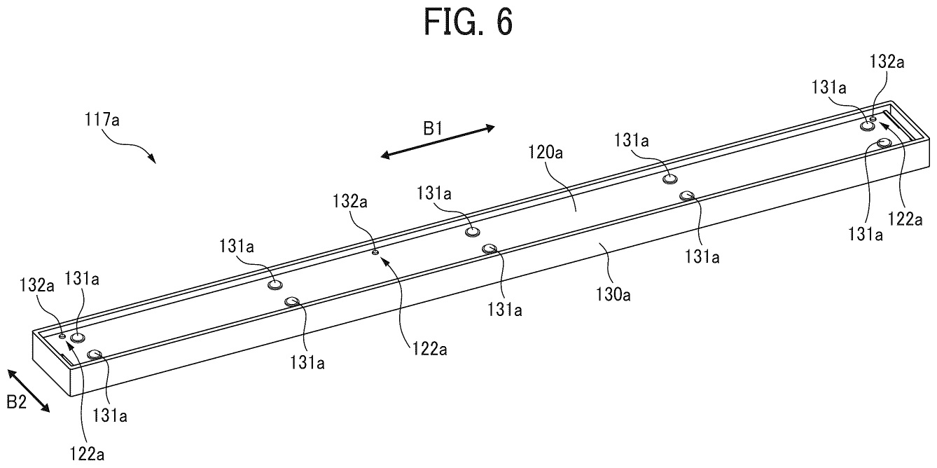

FIG. 6 is a perspective view of the first frame 130a to which the first imaging circuit board 120a is fixed, as viewed obliquely from above.

As illustrated in FIG. 6, the first imaging circuit board 120a is placed in the first frame 130a by fitting the first projections 131a and the second projections 132a of the first frame 130a into the facing first holes 121a and the facing second holes 122a of the first imaging circuit board 120a, respectively. The first imaging circuit board 120a is positioned relative to the first frame 130a by the second projections 132a and the second holes 122a. The end portion of each first projection 131a is melted by heat to expand in the main scanning direction B1 and the sub-scanning direction B2. Then, the first imaging circuit board 120a is fixed to the first frame 130a.

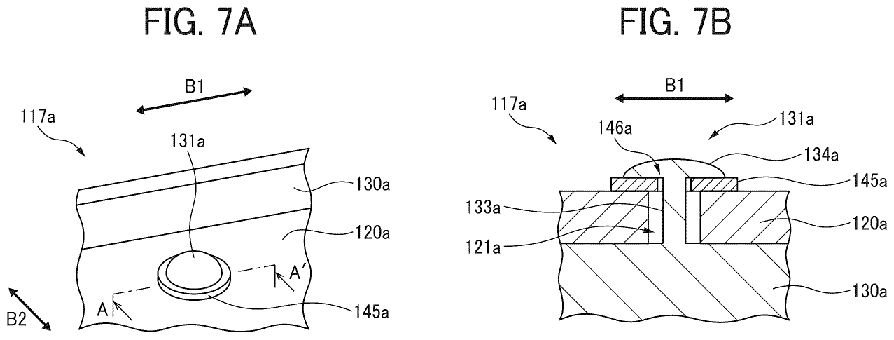

FIG. 7A is an enlarged view of a portion including the first projection 131a in the perspective view of FIG. 6. FIG. 7B is a cross-sectional view taken along line A-A′ in FIG. 7A.

As illustrated in FIGS. 7A and 7B, the first projection 131a includes a base 133a facing the first hole 121a, and an end portion 134a projecting from the first hole 121a. The first imager 117a further includes a restrictor 145a. The restrictor 145a is located between the end portion 134a of the first projection 131a and the first hole 121a.

The restrictor 145a is made of paper, metal, or resin. When the restrictor 145a is made of a resin material, the resin material preferably has a melting point higher than that of the first projection 131a. The restrictor 145a is circular when viewed from above. Alternatively, the restrictor 145a may have any shape such as an ellipse, a rectangle, or a rounded rectangle when viewed from above. The restrictor 145a has an opening 146a through which the base 133a passes. The opening 146a is formed at the center of the restrictor 145a. The opening 146a is circular when viewed from above. Alternatively, the opening 146a may have any shape such as an ellipse, a rectangle, or a rounded rectangle when viewed from above.

The first hole 121a is longer than the base 133a in the main scanning direction B1 and the sub-scanning direction B2, allowing clearance between the first hole 121a and the base 133a. Thus, the first imaging circuit board 120a is allowed to move relative to the first frame 130a in the main scanning direction B1 and the sub-scanning direction B2. The first hole 121a may have the same length as the length of the base 133a in the sub-scanning direction B2, allowing no clearance between the first hole 121a and the base 133a. In this case, the first imaging circuit board 120a is prevented from moving relative to the first frame 130a in the sub-scanning direction B2.

The restrictor 145a is longer than the end portion 134a and the first hole 121a in the main scanning direction B1 and the sub-scanning direction B2. In other words, the restrictor 145a restricts a part of the melted end portion 134a from flowing onto the first imaging circuit board 120a in the process of attaching the first imaging circuit board 120a to the first frame 130a, which will be described later. Thus, the first imaging circuit board 120a can smoothly move relative to the first frame 130a in any one of or both the main scanning direction B1 and the sub-scanning direction B2.

The end portion 134a is longer than the opening 146a and the first hole 121a in the main scanning direction B1 and the sub-scanning direction B2. The end portion 134a may be shorter than the first hole 121a in any one of or both the main scanning direction B1 and the sub-scanning direction B2. Thus, the end portion 134a restricts the restrictor 145a and the first imaging circuit board 120a from moving upward (floating), and secures the first imaging circuit board 120a to the first frame 130a in the height direction.

The opening 146a is equal to or longer than the base 133a and shorter than the first hole 121a in the main scanning direction B1 and the sub-scanning direction B2. The opening 146a is formed such that no clearance is present between the opening 146a and the base 133a or the clearance between the opening 146a and the base 133a is sufficiently small. Thus, the opening 146a allows the base 133a to pass therethrough while restricting a part of the melted end portion 134a from flowing into the first hole 121a in the process of attaching the first imaging circuit board 120a to the first frame 130a, which will be described later.

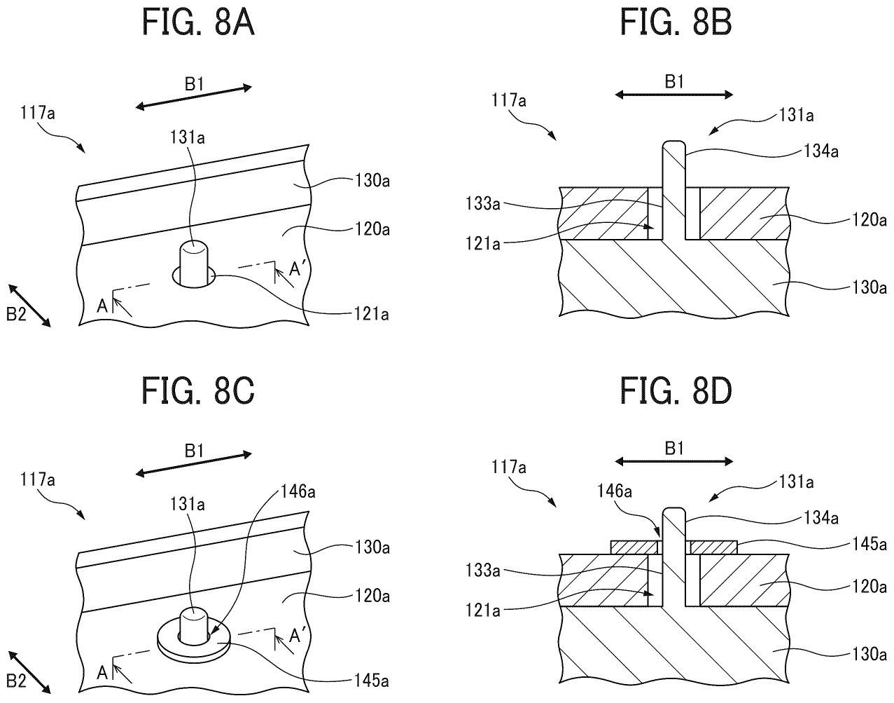

FIGS. 8A to 8D are schematic diagrams for explaining the process of attaching the first imaging circuit board 120a to the first frame 130a. FIGS. 8A and 8C are perspective views of the first imaging circuit board 120a and the first frame 130a as viewed obliquely from above. FIGS. 8B and 8D are cross-sectional views taken along line A-A′ of FIGS. 8A and 8C, respectively.

Initially, the first projections 131a and the second projections 132a of the first frame 130a are inserted into the facing first holes 121a and the facing second holes 122a of the first imaging circuit board 120a, respectively, as illustrated in FIGS. 8A and 8B (see also FIG. 6). Thus, the first imaging circuit board 120a is placed in the first frame 130a.

The first projections 131a before being melted in the process described later and the first holes 121a are circular when viewed from above. The first projections 131a before being melted and the first holes 121a may each have any shape such as an ellipse, a rectangle, or a rounded rectangle when viewed from above. Similarly, the second projections 132a and the second holes 122a are circular when viewed from above. The second projections 132a and the second holes 122a may each have any shape such as an ellipse, a rectangle, or a rounded rectangle when viewed from above.

In the main scanning direction B1 and the sub-scanning direction B2, the second holes 122a are longer than the second projections 132a, allowing clearance between the second hole 122a and the second projection 132a. In the sub-scanning direction B2, the second hole 122a may have the same length as the length of the second projection 132a, allowing no clearance between the second hole 122a and the second projection 132a.

Subsequently, the restrictor 145a is placed such that the first projection 131a projecting from the first hole 121a passes through the opening 146a as illustrated in FIGS. 8C and 8D.

Subsequently, the end portion 134a of the first projection 131a is melted by heat to expand in the main scanning direction B1 and the sub-scanning direction B2 and, becomes larger than the opening 146a when viewed from above as illustrated in FIGS. 7A and 7B. Thus, the upward movement of the first imaging circuit board 120a is restricted, and the first imaging circuit board 120a is fixed to the first frame 130a in the height direction. In this way, the first imaging circuit board 120a is fixed to the first frame 130a by the end portion 134a and the restrictor 145a.

As described above, the restrictor 145a is made of paper, metal, or resin having a melting point higher than that of the first projection 131a. This prevents the restrictor 145a from being melted by heat together with the end portion 134a of the first projection 131a.

As described above, the opening 146a of the restrictor 145a is shorter than the first hole 121a in the main scanning direction B1 and the sub-scanning direction B2, allowing almost no clearance between the opening 146a and the first projection 131a. Thus, the restrictor 145a restricts a part of the end portion 134a from flowing into the first hole 121a. This prevents the melted portion of the end portion 134a from filling the first hole 121a and solidifying therein. Accordingly, clearance is kept between the first hole 121a and the base 133a of the first projection 131a even after the end portion 134a is melted.

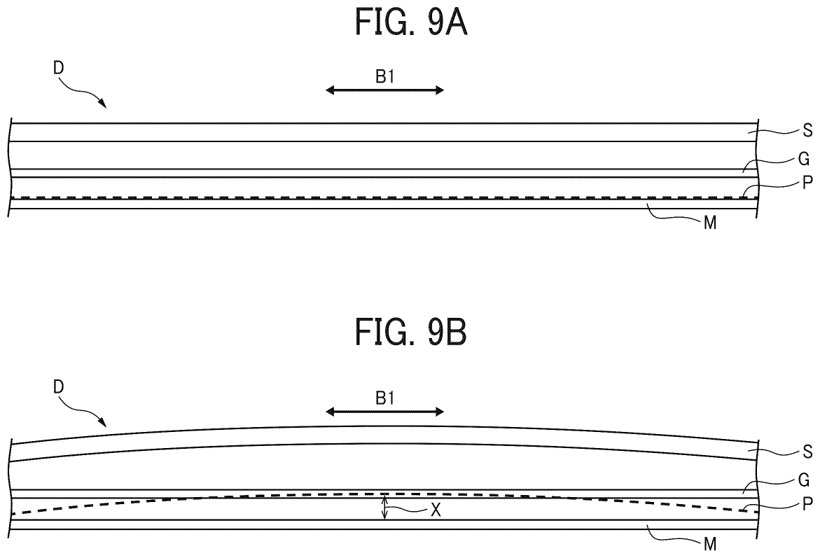

FIGS. 9A and 9B are schematic diagrams for explaining the technical significance of the restrictor 145a restricting a part of the melted end portion 134a from flowing into the first hole 121a.

FIGS. 9A and 9B illustrate an imager D in which the connected portion between an imaging circuit board and a frame is fixed in the main scanning direction B1, unlike the imager 117. FIG. 9A illustrates the imager D at room temperature, and FIG. 9B illustrates the imager D when the temperature changes.

As illustrated in FIG. 9A, a focus position P of an imaging sensor mounted on an imaging circuit board S is adjusted to match the position of a medium M conveyed along a glass G of the imager D.

Typically, an imaging circuit board (printed circuit board) is formed of a base made of, for example, paper or glass fabric, and a material such as resin having a low coefficient of linear expansion to increase durability, flame retardancy, etc. Examples of the resin include a phenol resin and an epoxy resin. By contrast, the frame of an imager is made of a material such as a resin having a high coefficient of linear expansion to reduce the cost and weight of the imager. Examples of the resin include polypropylene, polyethylene, polystyrene, and vinyl chloride resin. Accordingly, when the temperature changes, the imaging circuit board less easily shrinks, but the frame easily shrinks. When the connected portion between the imaging circuit board S and the frame is fixed in the main scanning direction B1, the frame shrinks in the main scanning direction B1 due to a temperature change in the environment in which the imager is used, causing the imaging circuit board S to warp in a bow shape between the connected portions as illustrated in FIG. 9B. As a result, the focus position P of the image sensor mounted on the imaging circuit board S is also warped in the main scanning direction B1, causing a deviation X between the focus position P and the medium M. Accordingly, an image generated by the imaging sensor is blurred.

By contrast, in the first imager 117a, since the restrictor 145a restricts a part of the melted end portion 134a from flowing into the first hole 121a, clearance is kept between the first hole 121a and the first projection 131a. Thus, the first imaging circuit board 120a is movable relative to the first frame 130a in the main scanning direction B1. Even when the first frame 130a shrinks in the main scanning direction B1 due to a temperature change in the environment in which the first imager 117a is used, the warpage of the first imaging circuit board 120a is reduced. This reduces the occurrence of deviation of the focus of the first imaging sensor 143a mounted on the first imaging circuit board 120a from the medium, thereby reducing the blurring of the image generated by the first imager 117a.

FIG. 10 is a schematic block diagram of a configuration of the image reading apparatus 100.

The image reading apparatus 100 further includes a motor 151, an interface device 152, a memory 160, and a processing circuit 170 in addition to the above-described components.

The motor 151 includes one or more motors. The motor 151 generates driving forces for rotating the pick roller 112, the feed roller 113, the separation roller 114, and the first to sixth conveyance rollers 115a to 115f to feed and convey media according to control signals from the processing circuit 170. The first to sixth driven rollers 116a to 116f may rotate receiving the driving force from the motor 151 instead of being rotated by the first to sixth conveyance rollers 115a to 115f. The motor 151 moves the media tray 103 according to a control signal from the processing circuit 170.

The interface device 152 includes an interface circuit compatible with a serial bus such as a universal serial bus (USB) and is electrically connected to an information processing device (for example, a personal computer or a mobile information processing terminal) to transmit and receive an input image and various kinds of information to and from an information processing device. A communication device that includes an antenna to transmit and receive wireless signals and a wireless communication interface circuit to transmit and receive signals through a wireless communication line according to a predetermined communication protocol may be used instead of the interface device 152. The predetermined communication protocol is, for example, a wireless local area network (LAN) communication protocol. The communication device may include a wired communication interface circuit to transmit and receive signals through a wired communication line according to, for example, a wired LAN communication protocol.

The memory 160 includes memories such as a random-access memory (RAM) and a read-only memory (ROM), a fixed disk device such as a hard disk, or a portable memory such as a flexible disk or an optical disk. The memory 160 stores computer programs, databases, tables, etc. used for various processes performed by the image reading apparatus 100. The computer programs may be installed in the memory 160 from a computer-readable portable recording medium using, for example, a known setup program. The portable recording medium is, for example, a compact disc read-only memory (CD-ROM) or a digital versatile disc read-only memory (DVD-ROM). The computer programs may be distributed from, for example, a server and installed in the memory 160.

The processing circuit 170 operates according to a program prestored in the memory 160. The processing circuit 170 is, for example, a central processing unit (CPU). Alternatively, a digital signal processor (DSP), a large-scale integration (LSI), an application-specific integrated circuit (ASIC), a field-programmable gate array (FPGA), etc. may be used as the processing circuit 170.

The processing circuit 170 is connected to the operation device 105, the display device 106, the media sensor 111, the imager 117, the motor 151, the interface device 152, the memory 160, etc. to control these devices. The processing circuit 170 controls the driving of the motor 151, the imaging by the imager 117, etc. according to the media signals received from the media sensor 111. The processing circuit 170 obtains an input image from the imager 117 and transmits the input image to the information processing device via the interface device 152.

FIG. 11 is a schematic block diagram of a configuration of the memory 160 and the processing circuit 170.

As illustrated in FIG. 11, the memory 160 stores a control program 161 and an image obtaining program 162. These programs are functional modules implemented by software that operates on the processor. The processing circuit 170 reads the programs from the memory 160 and operates according to the read programs. Thus, the processing circuit 170 functions as a control unit 171 and an image obtaining unit 172. The processing circuit 170 controls the imaging operation.

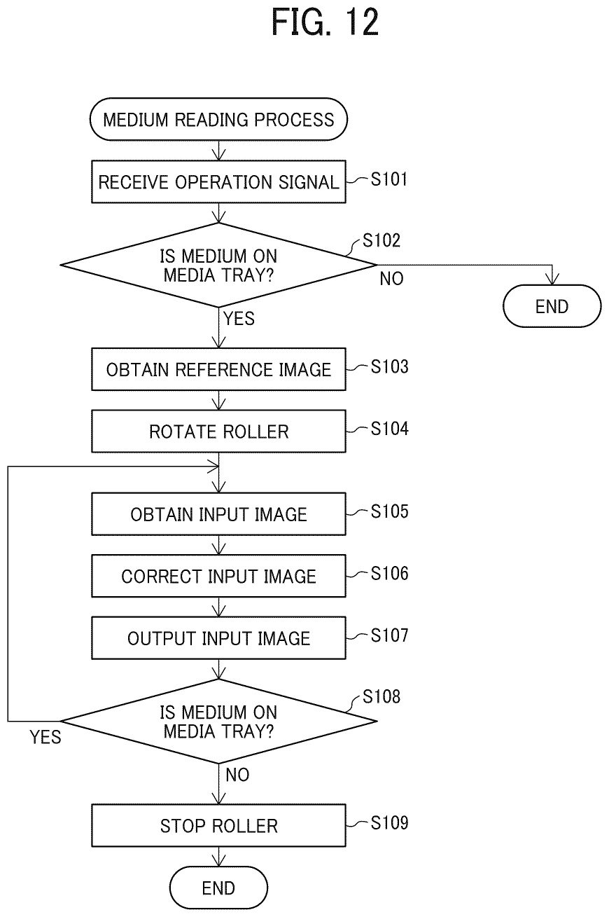

FIG. 12 is a flowchart of example operations in a medium reading process performed by the image reading apparatus 100.

Example operations in the medium reading process performed by the image reading apparatus 100 are described below with reference to the flowchart of FIG. 12. The process described below is executed by the processing circuit 170 in cooperation with the components of the image reading apparatus 100 according to the program prestored in the memory 160.

In step S101, the control unit 171 stands by until an operation signal instructing the reading of a medium is received from the operation device 105 or the interface device 152. The operation signal is output when a user inputs an instruction to read the medium using the operation device 105 or the information processing device.

In step S102, the control unit 171 obtains a media signal from the media sensor 111 and determines whether a medium is placed on the media tray 103 based on the obtained media signal. The control unit 171 ends the series of steps when no medium is placed on the media tray 103.

When a medium is placed on the media tray 103 (Yes in S102), the image obtaining unit 172 controls the imager 117 to image the first backing member 144a and the second backing member 144b, and obtains the reference images from the imager 117 (step S103).

The control unit 171 drives the motor 151 to move the media tray 103 to a position where the medium can be fed. In step S104, the control unit 171 also drives the motor 151 to rotate any one, some, or all of the pick roller 112, the feed roller 113, the separation roller 114, the first to sixth conveyance rollers 115a to 115f, and the first to sixth driven rollers 116a to 116f. Thus, the control unit 171 feeds the medium from the media tray 103.

In step S105, the image obtaining unit 172 controls the imager 117 to image the medium and obtains an input image from the imager 117.

In step S106, the image obtaining unit 172 corrects the obtained input image using the reference image obtained in step S103. The image obtaining unit 172 performs shading correction according to a known image processing technique on the input image with reference to the reference image.

In step S107, the image obtaining unit 172 transmits (i.e., outputs) the obtained input image to the information processing device via the interface device 152.

In step S108, the control unit 171 determines whether a medium remains on the media tray 103 based on the media signal received from the media sensor 111. When a medium remains on the media tray 103, the control unit 171 returns the processing to step S105 and repeats the processing in steps S105 to S108.

By contrast, when no medium remains on the media tray 103, the control unit 171 stops any one, some, or all of the pick roller 112, the feed roller 113, the separation roller 114, the first to sixth conveyance rollers 115a to 115f, and the first to sixth driven rollers 116a to 116f. The control unit 171 controls the motor 151 to stop the rollers. Further, the control unit 171 controls the motor 151 to return the media tray 103 to the initial position (step S109), and ends the series of steps.

As described above in detail, the image reading apparatus 100 includes the imager 117 including the CIS in which the first imaging circuit board 120a and the second imaging circuit board 120b are respectively fixed to the first frame 130a and the second frame 130b by thermal welding. The imager 117 includes a mechanism for restricting the melted material from flowing into the hole in each imaging circuit board when the end portions of the projections on the frame are melted. Accordingly, in the imager 117, clearance is kept between each hole and the corresponding projection. Thus, the warpage of the imaging circuit boards is reduced even when the frames shrink in the main scanning direction B1 due to a change in temperature of the environment in which the imager 117 is used. Accordingly, the imager 117 can reduce the occurrence of the deviation of focus.

In particular, when the imager 117 includes a line sensor based on a CIS having a shallow depth of field, the influence on the deviation of focus is large when the line sensor is misaligned with the medium. The imager 117 can reduce the occurrence of deviation of focus and the blur of the input image by reducing the warpage of the imaging circuit board even when a line sensor based on a CIS is used.

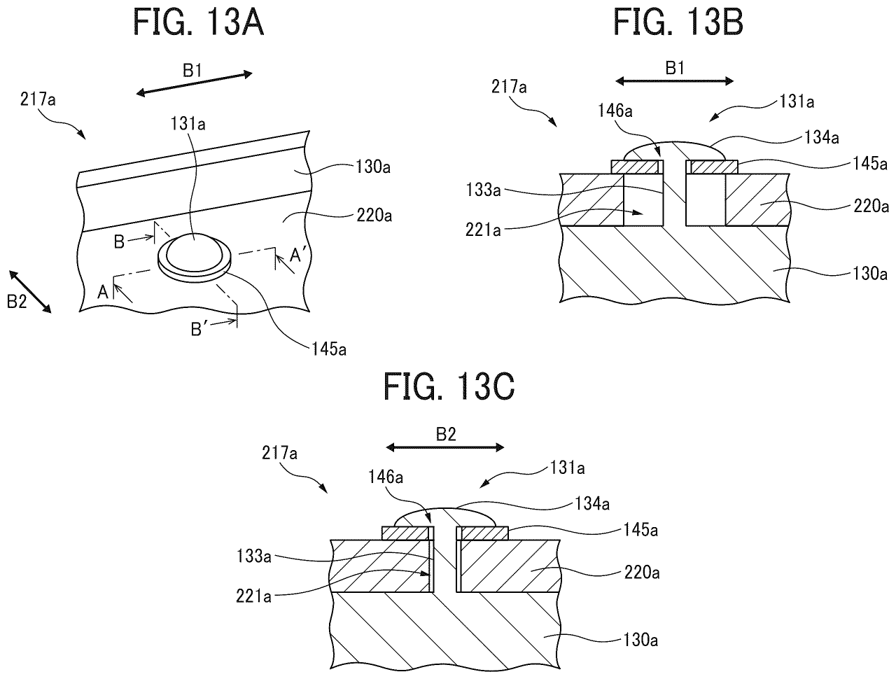

FIGS. 13A to 13C are schematic diagrams for explaining an imager according to another embodiment. FIG. 13A is a perspective view of a first imaging circuit board 220a and the first frame 130a as viewed obliquely from above. FIGS. 13B and 13C are cross-sectional views taken along lines A-A′ and B-B′in FIG. 13A, respectively. Since the structures of the first imager and the second imager are similar also in the present embodiment, the first imager will be described below as a representative.

A first imager 217a illustrated in FIGS. 13A to 13C is similar in configuration and function to the first imager 117a. However, the first imager 217a includes a first imaging circuit board 220a instead of the first imaging circuit board 120a as illustrated in FIGS. 13A to 13C. The first imaging circuit board 220a is similar in configuration and function to the first imaging circuit board 120a. However, the first imaging circuit board 220a includes a first hole 221a instead of the first hole 121a. The first hole 221a is an example of the hole.

The first hole 221a is rounded rectangular when viewed from above and is longer in the main scanning direction B1 than in the sub-scanning direction B2. The first hole 221a may have any shape such as an elliptical shape or a rectangular shape that is longer in the main scanning direction B1 than in the sub-scanning direction B2 when viewed from above.

The first hole 221a is longer than the base 133a in the main scanning direction B1 and the sub-scanning direction B2, allowing clearance between the first hole 221a and the base 133a. Thus, the first imaging circuit board 220a is allowed to move relative to the first frame 130a in the main scanning direction B1 and the sub-scanning direction B2. The first hole 221a may have the same length as the length of the base 133a in the sub-scanning direction B2, allowing no clearance between the first hole 221a and the base 133a. In this case, the first imaging circuit board 220a is prevented from moving relative to the first frame 130a in the sub-scanning direction B2.

The clearance between the first hole 221a and the base 133a of the first projection 131a is larger in the main scanning direction B1 than in the sub-scanning direction B2 in the first imaging circuit board 220a. Accordingly, the first imaging circuit board 220a is fixed to (positioned relative to) the first frame 130a with little clearance to move in the sub-scanning direction B2 but is movable in the main scanning direction B1. Accordingly, the first imaging sensor 143a can stably image a medium without swinging in the sub-scanning direction B2. Further, the warpage of the first imaging circuit board 220a is reduced even when the first frame 130a shrinks in the main scanning direction B1 due to a temperature change in the environment in which the first imager 217a is used. This reduces the occurrence of deviation of the focus of the first imaging sensor 143a mounted on the first imaging circuit board 220a from the medium, thereby reducing the blurring of the image generated by the first imager 217a.

The relationship between the lengths of the restrictor 145a, the end portion 134a, and the opening 146a and the length of the first hole 221a is like the relationship between the lengths of the restrictor 145a, the end portion 134a, and the opening 146a and the length of the first hole 121a.

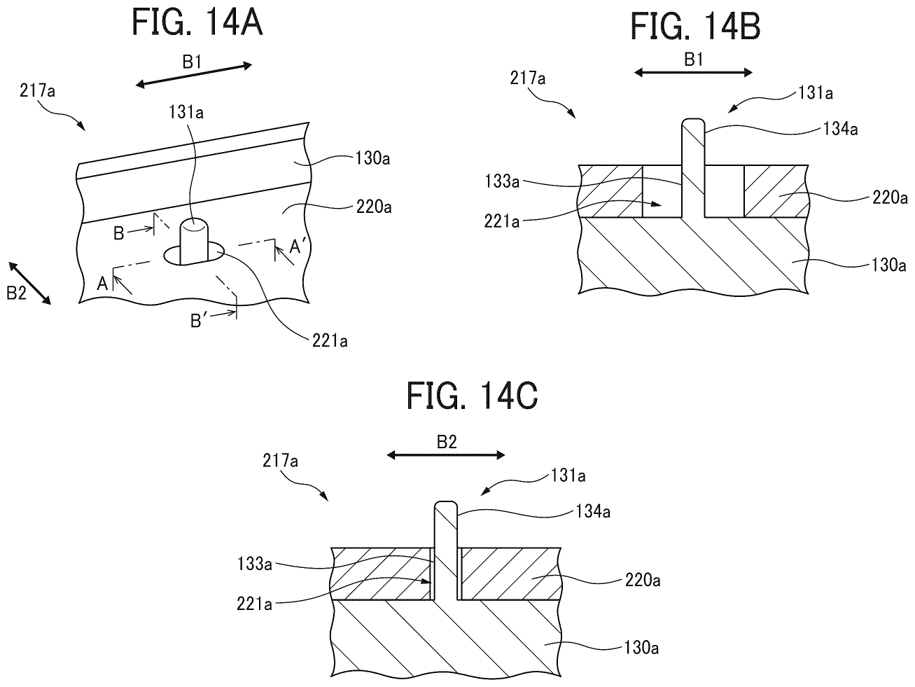

FIGS. 14A to 14C are schematic diagrams for explaining the process of attaching the first imaging circuit board 220a to the first frame 130a. FIG. 14A is a perspective view of the first imaging circuit board 220a and the first frame 130a as viewed obliquely from above. FIGS. 14B and 14C are cross-sectional views taken along lines A-A′ and B-B′ in FIG. 14A, respectively.

Initially, the first projections 131a and the second projections 132a of the first frame 130a are inserted into the facing first holes 221a and the facing second holes 122a of the first imaging circuit board 220a, respectively, as illustrated in FIGS. 14A to 14C (see also FIG. 6). Thus, the first imaging circuit board 220a is placed in the first frame 130a. Subsequently, the restrictor 145a is placed such that the first projection 131a projecting from the first hole 221a passes through the opening 146a.

Subsequently, the end portion 134a of the first projection 131a is melted by heat to expand in the main scanning direction B1 and the sub-scanning direction B2 and becomes larger than the first hole 221a and the opening 146a when viewed from above as illustrated in FIGS. 13A to 13C. In this way, the first imaging circuit board 220a is fixed to the first frame 130a by the end portion 134a and the restrictor 145a.

As described above in detail, the imager illustrated in FIGS. 13A to 14C can reduce the occurrence of deviation of focus even when the clearance between the hole and the base is larger in the main scanning direction B1 than in the sub-scanning direction B2.

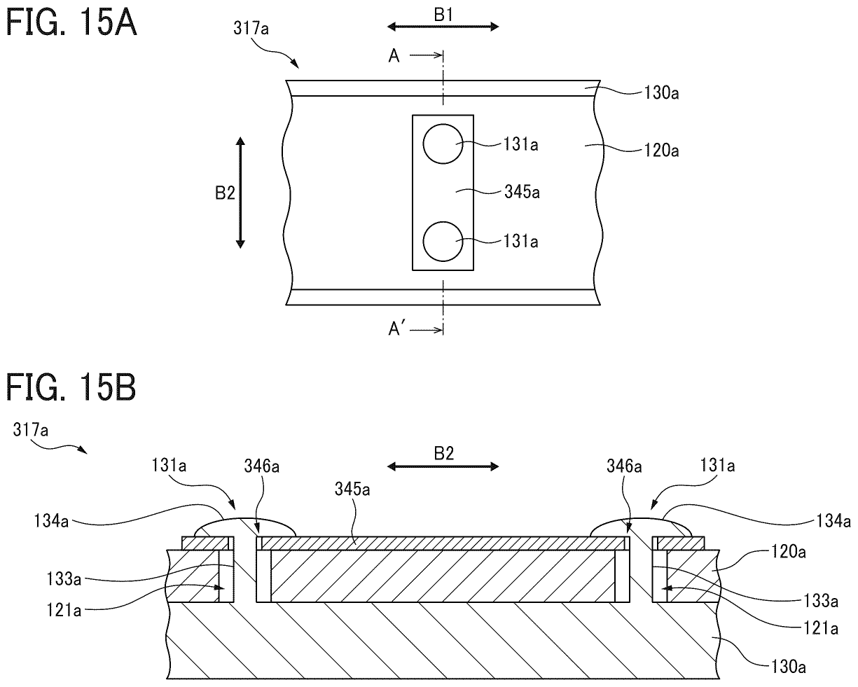

FIGS. 15A and 15B are schematic diagrams for explaining an imager according to still another embodiment. FIG. 15A is a plan view of the first frame 130a to which the first imaging circuit board 120a is fixed as viewed from above. FIG. 15B is a cross-sectional view taken along line A-A′ in FIG. 15A. Since the structures of the first imager and the second imager are similar also in the present embodiment, the first imager will be described below as a representative.

A first imager 317a illustrated in FIGS. 15A and 15B is similar in configuration and function to the first imager 117a. However, the first imager 317a includes a restrictor 345a instead of the restrictor 145a as illustrated in FIGS. 15A and 15B. Multiple openings 346a through which respective bases 133a of the first projections 131a pass are formed in the restrictor 345a. Since one restrictor 345a restricts the melted portion of the end portions 134a from flowing into the first holes 121a, the cost of the components of the first imager 317a can be reduced.

As described above in detail, the imager illustrated in FIGS. 15A and 15B can reduce the occurrence of deviation of focus even when the multiple openings 346a are formed in one restrictor 345a.

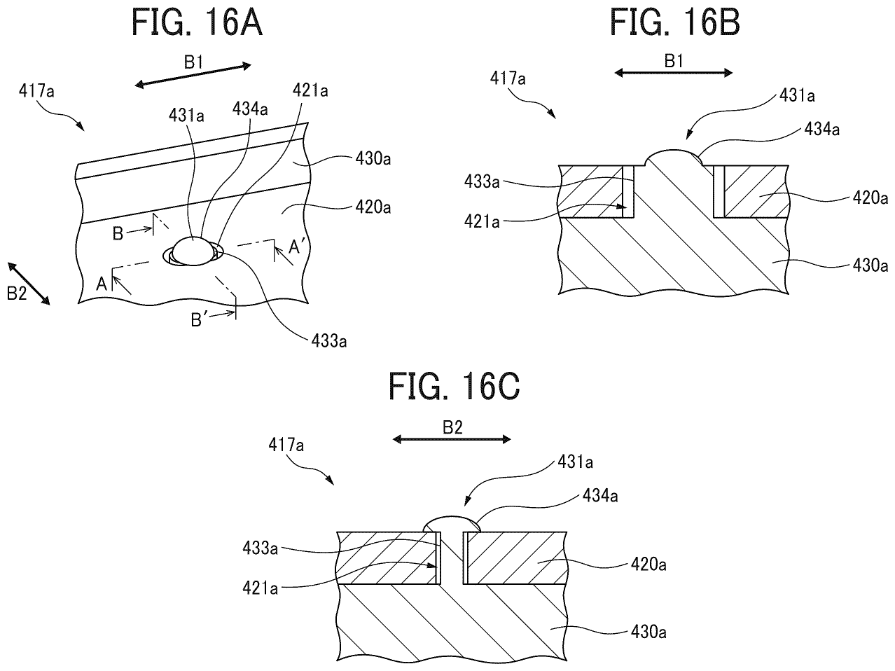

FIGS. 16A to 16C are schematic diagrams for explaining an imager according to still another embodiment. FIG. 16A is a perspective view of a first imaging circuit board 420a and a first frame 430a as viewed obliquely from above. FIGS. 16B and 16C are cross-sectional views taken along lines A-A′ and B-B′in FIG. 16A, respectively. Since the structures of the first imager and the second imager are similar also in the present embodiment, the first imager will be described below as a representative.

A first imager 417a illustrated in FIGS. 16A to 16C is similar in configuration and function to the first imager 117a. However, the first imager 417a includes the first imaging circuit board 420a and the first frame 430a instead of the first imaging circuit board 120a and the first frame 130a and does not include the restrictor 145a as illustrated in FIGS. 16A to 16C. The first imaging circuit board 420a is similar in configuration and function to the first imaging circuit board 120a. However, the first imaging circuit board 420a includes a first hole 421a instead of the first hole 121a. The first hole 421a is an example of the hole. The first frame 430a is similar in configuration and function to the first frame 130a. However, the first frame 430a includes a first projection 431a instead of the first projection 131a. The first projection 431a is an example of the projection.

The first projection 431a includes a base 433a facing the first hole 421a and an end portion 434a projecting from the first hole 421a.

The base 433a and the first hole 421a are rounded rectangular when viewed from above. The base 433a and the first hole 421a may have any shape such as a circle, an ellipse, or a rectangle when viewed from above.

The first hole 421a is longer than the base 433a in the main scanning direction B1 and the sub-scanning direction B2, allowing clearance between the first hole 421a and the base 433a. Thus, the first imaging circuit board 420a is allowed to move relative to the first frame 430a in the main scanning direction B1 and the sub-scanning direction B2. The first hole 421a may have the same length as the length of the base 433a in the sub-scanning direction B2, allowing no clearance between the first hole 421a and the base 433a. In this case, the first imaging circuit board 420a is prevented from moving relative to the first frame 430a in the sub-scanning direction B2.

In the sub-scanning direction B2, the length (width) of the end portion 434a is longer than the length (width) of the base 433a. Thus, the end portion 434a restricts the first imaging circuit board 420a from moving upward (floating), and secures the first imaging circuit board 420a to the first frame 430a in the height direction.

By contrast, the length (width) of the end portion 434a is equal to or less than the length (width) of the base 433a in the main scanning direction B1. Thus, the base 433a restricts a portion of the melted end portion 434a from flowing into the first hole 421a from the clearance at the end in the main scanning direction B1 in the process of attaching the first imaging circuit board 420a to the first frame 430a, which will be described later.

The first hole 421a and the base 433a are formed such that no clearance is present between the first hole 421a and the base 433a or the clearance between the first hole 421a and the base 433a is sufficiently small in the sub-scanning direction B2. Thus, the base 433a restricts a portion of the melted end portion 434a from flowing into the first hole 421a from the clearance at the end in the sub-scanning direction B2 in the process of attaching the first imaging circuit board 420a to the first frame 430a, which will be described later.

In particular, the clearance between the first hole 421a and the base 433a is preferably larger in the main scanning direction B1 than in the sub-scanning direction B2. This allows the first imaging circuit board 420a to be fixed to (positioned relative to) the first frame 430a with little clearance to move in the sub-scanning direction B2 but is movable in the main scanning direction B1. Accordingly, the first imaging sensor 143a can stably image a medium without swinging in the sub-scanning direction B2. Further, the warpage of the first imaging circuit board 420a is reduced even when the first frame 430a shrinks in the main scanning direction B1 due to a temperature change in the environment in which the first imager 417a is used. This reduces the occurrence of deviation of the focus of the first imaging sensor 143a mounted on the first imaging circuit board 420a from the medium, thereby reducing the blurring of the image generated by the first imager 417a.

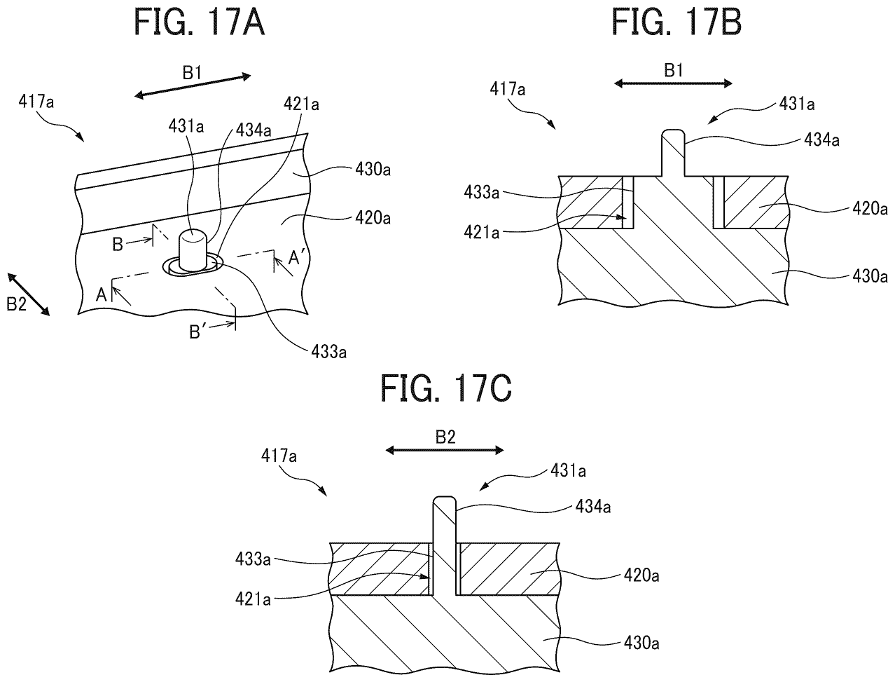

FIGS. 17A to 17C are schematic diagrams for explaining the process of attaching the first imaging circuit board 420a to the first frame 430a. FIG. 17A is a perspective view of the first imaging circuit board 420a and the first frame 430a as viewed from obliquely above. FIGS. 17B and 17C are cross-sectional views taken along lines A-A′ and B-B′ in FIG. 17A, respectively.

Initially, the first projections 431a and the second projections 132a of the first frame 430a are inserted into the facing first holes 421a and the facing second holes 122a of the first imaging circuit board 420a, respectively, as illustrated in FIGS. 17A to 17C (see also FIG. 6). Thus, the first imaging circuit board 420a is placed in the first frame 430a.

The end portion 434a before being melted in the process described later is circular when viewed from above. The end portion 434a before being melted may have any shape such as an ellipse, a rectangle, or a rounded rectangle when viewed from above.

The end portion 434a before being melted is equal to or shorter than the bases 433a in the sub-scanning direction B2. The end portion 434a may be longer than the base 433a and equal to or shorter than the first hole 421a in the sub-scanning direction B2. Thus, the end portion 434a before being melted can pass through the first hole 421a, and the first imaging circuit board 420a is appropriately placed in the first frame 430a.

The end portion 434a before being melted is shorter than the base 433a in the main scanning direction B1. Thus, in the process described later, the base 433a receives a part of the melted end portion 434a and restricts the part of the melted end portion 434a from flowing into the first hole 421a from the clearance at the end in the main scanning direction B1.

Subsequently, as illustrated in FIGS. 16A to 16C, the end portion 434a of the first projection 431a is melted to expand in the sub-scanning direction B2 and becomes larger than the first hole 421a in the sub-scanning direction B2 when viewed from above.

Thus, the upward movement of the first imaging circuit board 420a is restricted, and the first imaging circuit board 420a is fixed to the first frame 430a in the height direction. In this way, the first imaging circuit board 420a is fixed to the first frame 430a by the end portion 434a in the sub-scanning direction B2.

A part of the melted end portion 434a is expanded also in the main scanning direction B1 but is received by the base 433a. Thus, the base 433a restricts a part of the melted end portion 434a from flowing into the first hole 421a in the main scanning direction B1. Accordingly, clearance is kept between the first hole 421a and the base 433a of the first projection 431a even after the end portion 434a is melted.

As described above in detail, the imager illustrated in FIGS. 16A to 17C can reduce the occurrence of deviation of focus even when the width of the end portion 434a is equal to or less than the width of the base 433a in the main scanning direction B1.

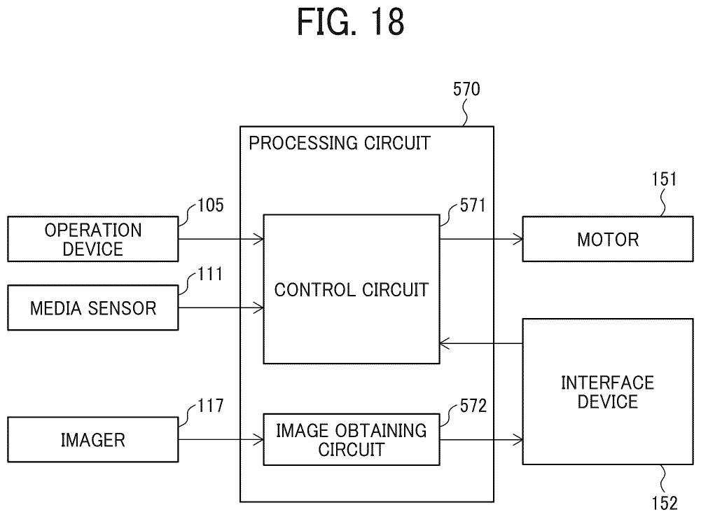

FIG. 18 is a schematic block diagram of a processing circuit of an image reading apparatus according to still another embodiment.

A processing circuit 570 illustrated in FIG. 18 is used instead of the processing circuit 170 of the image reading apparatus 100 and executes the overall processing, medium-related processing, etc., instead of the processing circuit 170. The processing circuit 570 includes a control circuit 571 and an image obtaining circuit 572. These circuits may be implemented by independent integrated circuits, microprocessors, firmware, or a combination thereof.

The control circuit 571 is an example of the control unit and functions like the control unit 171. The control circuit 571 receives operation signals from the operation device 105 or the interface device 152 and receives media signals from the media sensor 111. The control circuit 571 controls the motor 151 based on the received signals.

The image obtaining circuit 572 is an example of the image obtaining unit and has a similar function to the image obtaining unit 172. The image obtaining circuit 572 obtains the reference image and the input image from the imager 117, corrects the input image based on the reference image, and outputs the corrected input image to the interface device 152.

As described above in detail, the image reading apparatus can appropriately reduce the occurrence of deviation of focus also when the processing circuit 570 is used.

Although exemplary embodiments are described above, the embodiments are not limited thereto. For example, in the imager, not only the imaging sensor but also any one of or both the light source and the backing member may be mounted on the imaging circuit board. When the light source is mounted on the imaging circuit board, unevenness in the light emitted to the medium in the main scanning direction B1 is prevented or reduced by reducing the warpage of the imaging circuit board. In addition, when the backing member is mounted on the imaging circuit board, unevenness in the reference image in the main scanning direction B1 is reduced by reducing the warpage of the imaging circuit board, which reduces unevenness in the input image that is corrected based on the reference image.

The image reading apparatus may include a so-called straight path to feed the media on the media table in order from the bottom. In this case, the feed roller is located below the separation roller to face the separation roller. The image reading apparatus may be a so-called flatbed scanner, facsimile, copier, multifunction printer, or the like that images a medium without conveying the medium. In this case, the imager is movable in the sub-scanning direction by a driving force from the motor.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general-purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a CD-ROM or DVD, and/or the memory of an FPGA or ASIC.

1. An imager comprising:
an imaging circuit board including a hole;
a frame including a projection that includes a base and an end portion projecting from the hole; and
a restrictor located between the end portion and the hole, wherein the restrictor includes an opening through which the base passes,
wherein the imaging circuit board is fixed to the frame by the end portion and the restrictor, and the opening is smaller than the hole in a main scanning direction of the imaging circuit board.

2. The imager according to claim 1,
wherein the restrictor restricts a part of the end portion that is melted from flowing into the hole.

3. The imager according to claim 1,
wherein the restrictor includes paper, metal, or resin.

4. The imager according to claim 1,
wherein clearance between the hole and the base is larger in the main scanning direction than in a sub-scanning direction in the imaging circuit board.

5. An image reading apparatus comprising:
the imager according to claim 1; and
control circuitry configured to control imaging operation performed by the imager.

6. An imager comprising:
an imaging circuit board including a hole; and
a frame including a projection that includes a base and an end portion projecting from the hole, wherein
the end portion is longer than the base in a sub-scanning direction of the imaging circuit board and is equal to or shorter than the base in a main scanning direction of the imaging circuit board, and
the imaging circuit board is fixed to the frame by the end portion in the sub-scanning direction.

7. The imager according to claim 6,
wherein the base restricts a part of the end portion that is melted from flowing into the hole in the main scanning direction of the imaging circuit board.

8. The imager according to claim 6,
wherein clearance between the hole and the base is larger in the main scanning direction than in the sub-scanning direction.

9. An image reading apparatus comprising:
the imager according to claim 6; and
control circuitry configured to control imaging operation performed by the imager.
